(19) United States
(12) Patent Application Publication
(10) Pub. No.: US 2024/0025793 A1
(43) Pub. Date: Jan. 25, 2024

(54) TIP PLATE FOR A BUSHING AND BUSHING

(71) Applicant: Cookson Precious Metals Ltd., Birmingham (GB)

(72) Inventors: Günther Mager, Stolberg (DE); Ian Campbell, Kenilworth, Warwickshire (GB)

(73) Assignee: Cookson Precious Metals Ltd., Birmingham (GB)

(21) Appl. No.: 18/042,966

(22) PCT Filed: Aug. 19, 2021
(86) PCT No.: PCT/EP2021/073063

§ 371 Date: Feb. 24, 2023

(30) Foreign Application Priority Data
Aug. 31, 2020 (DE) 102020005323.8

(51) Int. Cl. C03B 37/083; B33Y 80/00

(52) U.S. Cl. CPC C03B 37/083; B33Y 80/00

(57) ABSTRACT

The invention relates to a tip plate for a bushing for receiving a high temperature melt and a corresponding bushing, wherein the tip plate provides an arrangement of tips of high packing density.

The invention relates to a tip plate for a bushing for receiving a high temperature melt and a corresponding bushing. The term “receiving” includes all kinds of preparing, storing and treating melts. In particular the bushing and its tip plate are intended for use in the production of fibres, such as glass fibres, mineral fibres, basalt fibres etc.

Prior art and the invention will be described hereinafter in more detail with reference to the production of and an apparatus for producing glass fibres, including textile glass fibres, although not limited to such use.

Glass fibres have been manufactured from a glass melt by means of bushings for more than 100 years. A general overview may be derived from “Design and Manufacture of Bushings for Glass Fibre Production”, published by HVG Hüttentechnische Vereinigung der Deutschen Glasindustrie, Offenbach in connection with the glasstec 2006 exhibition in Dusseldorf.

A generic bushing may be characterized as a box like melting vessel (crucible), often providing a cuboid space and comprising a bottom, the so called tip plate, as well as a circumferential wall.

A generic tip plate comprises a body between an upper surface and a lower surface at a distance to the upper surface as well as a multiplicity of so-called tips (also called nozzles and/or orifices), extending between the upper surface and the lower surface and through said body, through which tips/nozzles/orifices the melt may leave the bushing, in most cases under the influence of gravity.

The tip plate requires high temperature resistant and thus expensive materials like precious metals to withstand the high temperature melt (e.g. up to 1700° C.). The design and arrangement of the nozzles in a generic tip plate varies and depends on the local conditions in a glass fibre plant and on the target product. While the tips often have an inner diameter of 1-4 mm and a length of 2-8 mm, the number of tips of one tip plate may be up to a few thousand. In various embodiments the tips protrude the lower surface of the tip plate—in the flow direction of the melt, being the z-direction during use—.

Several attempts have been made in the past to arrange as many tips as possible per unit area to reduce the quantity and thus the costs of the precious metals required to manufacture a tip plate with a certain number of tips. The number of tips (with corresponding flow-through openings) per unit area has been referred to in prior art as the “packing density” of the tip plate.

To realize a high packing density U.S. Pat. No. 5,062,876 A discloses a tip plate, wherein the lower end of the tips is substantially a regular polygon in shape. The realization of regular polygonal shapes in connection with tips welded to a tip plate is difficult with conventional manufacturing techniques, leads to an irregular flow of a glass melt through such orifices and causes difficulties in heat dissipation.

For example: the speed of the fibres drawn from such an orifice (tip, nozzle) downwardly may be around 1000 meters per minute and allows the formation of very thin continuous glass fibre filaments with diameters of even less than 50 μm, often 4 to 35 μm.

It is an object of the invention to overcome as much as possible of the known drawbacks and in particular to provide a tip plate with a high packing density (and thus a favorable relation: number of tips/required precious metal mass), an excellent service life and/or allowing a glass fibre production of high uniformity and quality.

The invention is based on the following findings:

One limiting factor to achieve higher packing densities (of tips) compared with prior art tip plates is the arrangement of nozzles (tips) and thus the arrangement of the flow-through openings at the upper surface of the tip plate. This is true in particular if the tips are fixed to the tip plate by welding or punching. In its use position this upper surface is fully covered by the glass melt and the hydrostatic pressure is high as the bushing comprises a certain volume of said glass melt.

Typically the tips are arranged one behind the other in a row, i.e. side by side with their central longitudinal axes intersecting a common virtual straight line. At least a further multiplicity of tips is arranged along at least one further (common) virtual straight line in a further row and the lines (rows) extend parallel to each other, altogether forming a group of tips. A third, fourth etc. similar arrangement may be added. Several groups are spaced to each other so that a so called cooling fin may be arranged at the lower surface of the tip plate and between adjacent groups. The tips may also be arranged as double, triple, quadruple etc. rows with intermediate cooling fins.

To allow high melt flow rates through the tips of the tip plate, relatively large flow-through orifices at the upper surface of the tip plate may be used. To avoid a contact between melt particles (drops) deriving from adjacent tips at their opposite (lower, exit) end, the respective distance between adjacent tips at their lower end (in the operating position) should be as large as possible. A larger distance at the melt outlet end of the tips further allows an improved cooling around the tips. The combination of these design features at both ends of the tips leads to a synergetic behavior with respect to production rate and production reliability, melt flow characteristic and fibre quality. A corresponding design also leads to a high packing density and a high flow rate of the melt through the tips.

While the minimum distance between adjacent virtual straight lines at the upper surface of the tip plate is defined by an arrangement wherein adjacent orifices touch each other at corresponding points at their outer periphery, the maximum distance must be smaller than the diameter of the respective orifices at the upper surface. Correspondingly orifices which are arranged along different virtual lines but adjacent to each other lead to an “overlap” as will be described in further detail hereinafter.

Due to manufacturing reasons (notwithstanding manufacturing tolerances or limits) and the required quality of glass fibres it is assumed that the majority of tips (>50%, often >70%, >80%, >90%) are of substantially same dimensions, especially their flow through openings are of the same design and cross-section. This is in particular true for the tips arranged along a central section of the tip plate.

There is a geometric relation between the distance of adjacent lines of tips (orifices), the diameter of the tips (orifices), in particular at the upper surface of the tip plate, and the distance of adjacent tips. For example: if the distance between the virtual straight lines mentioned is larger than the diameter of the tips at the upper surface, the packing density worsens characteristically. The same is true if the distance between adjacent tips of one line is enlarged to an extent that the same distance to a tip of the adjacent line would require a distance between the two lines of larger than the diameter of the tips at the tip plate surface.

The volumetric flow through a cylindrical pipe (here: the flow-through opening of a tip) can be calculated according to the Hagen-Poiseuilles equation for laminar flow:

$$V = \frac{π \cdot {D}^{4} \cdot Δ p}{128 \cdot η \cdot L}$$

wherein
V=volumetric flow rate in m³/s
D=tip diameter in m
Δp=pressure difference in Pa
η=dynamic viscosity in Pa s
L=tip length in m

Correspondingly the mass flow rate Pₛ of the melt is calculated as

$${P}_{s} = \frac{π \cdot g}{128} \cdot \frac{{ρ}^{2} \cdot H}{η} \cdot \frac{{D}^{4}}{L}$$

with
g=earth's gravity, ρ=density of the melt in kg/m3 and H=pressure head in m

In case of a non circular cross section of the pipe (flow-through opening) the following geometry factor Q replaces D⁴/L:

$${P}_{s} = \frac{π \cdot g}{128} \cdot \frac{{ρ}^{2} \cdot H}{η} \cdot Q$$

$$with Q = \frac{3 \cdot {d}_{1}^{3} \cdot {d}_{2}^{3}}{L \cdot ( {d}_{1}^{2} + {d}_{1} \cdot {d}_{2} + {d}_{2}^{2} )}$$

for frustums, wherein d1 defines the larger diameter, d2 the smaller diameter and L is again the length of the tip, all in m (Meter).

Notwithstanding that external effects like temperature, environmental turbulences etc. are not regarded in this equation it may be used for the calculation of tips according to the invention.

With respect to the present invention an important finding is to set the distance of the central longitudinal axes of the tips in relation to the mass flow rate, in other words: to make the distance as small as possible while keeping the mass (melt) flow rate constant.

In its most general embodiment the invention relates to a tip plate for a bushing for receiving a high-temperature melt, comprising—in its operational position—an upper surface, which extends in two directions (x,y) of the coordinate system, a lower surface at a distance to the upper surface and a body in between, as well as a multiplicity of tips with flow-through openings of substantially circular cross-section in the x-y-directions and their largest diameter (dmax) adjacent to the upper surface of the tip plate, which tips extend from the upper surface through the body and protrude the lower surface and through which the high-temperature melt may leave the tip plate in a third (z) direction of the coordinate system, wherein
a first multiplicity of tips being arranged side by side such that a central longitudinal axis of each corresponding flow-through opening intersects a (common) virtual first straight line and adjacent central longitudinal axes have a distance (dT1) of ≥1.0 dmax to ≤1.3 dmax,
a second multiplicity of tips being arranged side by side such that a central longitudinal axis of each corresponding flow-through opening intersects a (common) virtual second straight line and adjacent central longitudinal axes have a distance (dT2) of ≥1.0 dmax to ≤1.3 dmax,
the virtual first straight line and the virtual second straight line extend parallel to each other at a distance dL=≥0.866 dmax and <1.0 dmax.

A distance dL=0,866 dmax and distances dT1 and dT2=1 dmax define an arrangement with which adjacent tips touch each other at one point on their outer periphery.

A distance dL=dmax defines the farthest distance between two adjacent virtual lines which allow at least a point contact between adjacent tips of two lines.

Upper limits of dL may also be set at <1.0, <0.97 or <0.95.

While the invention refers to tips with flow-through openings featuring a substantially circular cross section in an x-y-direction, this includes exactly circular cross sections and in an embodiment flow through openings featuring slightly different cross sectional profiles but with a substantially overall circular profile, e.g. polygonal profiles, which will work as well. In this context the dimensions of a typical tip plate are of importance:
length: 200-1500 mm
width: 50-400 mm
thickness (without protruding part of the tips): 1-3 mm
tip: length (part protruding the body of the tip plate): 2-5 mm
tip: outer/inner diameter at the upper surface of the tip plate: 1.5-4.5 mm/1.0-4.0 mm
tip: outer/inner diameter at the opposite end: 1.5-4.5 mm/1.0-4.0 mm

As far as the invention refers to “substantially circular cross-section”, this is not to be understood in an exact geometric sense but technically. In case of a slightly non-circular cross section the (one) “diameter” will be replaced by the so called diameter equivalent.

With respect to the arrangement of the tips along a virtual straight line it may be understood that a distance of central longitudinal axes of adjacent tips of slightly less than 1.0 dmax (in particular down to a minimum of 0.9 dmax) are possible as well, although this leads to a certain intersection of adjacent circular openings of adjacent tips at the upper surface of the tip plate and thus to certain irregularities in the melt's flow behavior along respective cross sections of such tips (nozzles).

The invention also provides a manufacturing technique, namely additive manufacturing, which allows high precision designs and a further flexibility and freedom with respect to tip geometry. In particular the tip plate may be manufactured as one monolithic part, i.e. with tips (nozzles) which are shaped together with the tip plate body. This has considerable advantages over welding or punching technologies to shape the tips.

Optional features of the invention include the following, either individually or in connection with other features as long as technically feasible:
The largest diameter of the tips (their orifices) may be exactly at the upper surface of the tip plate, although a slightly recessed design will be acceptable as well.
More than 50% of the central longitudinal axes of corresponding flow-through openings along each virtual straight line may have the same distance (dT1, dT2) to each other; in other words: corresponding tips may have an equal distance to each other. This design may be realized at tips along ≥70, ≥80 up to 100% of the length of a line.
More than 50% of the central longitudinal axes of adjacent flow-through openings of all tips along the virtual first and second straight line may have the same distance to each other. This arrangement may lead to a design wherein the virtual connection of central longitudinal axes of three adjacent tips (on two adjacent lines) leads to an equilateral triangle, being a favorable design according to the invention. Again such arrangements may be realized with tips along ≥70%, ≥80% up to 100% of the length of the lines.
The distance dT1 (between adjacent tips along one line) and/or dT2 (between adjacent tips along an adjacent line) may be limited to <1.2 dmax, <1.15 dmax or even <1.1 dmax. The smaller dT1 and/or dT2 the higher the packing density.
More than 50% of the central longitudinal axes of the flow-through openings of all tips along the virtual first and second straight line may be are arranged such that the central longitudinal axes of two adjacent through openings along one straight line and one flow-through opening of the adjacent straight line form an isosceles triangle or even an equilateral triangle. The 50% value may be increased to ≥70%, ≥80%, ≥90% up to 100%.
In another embodiment the flow-through openings have an inner shape, which corresponds over at least 70% of their total length to a frustum with its larger diameter toward the upper surface of the tip plate. The value of 70% may be increased to ≥80%, ≥90% or even 100%. A further embodiment relates to flow-through openings which have an inner shape, which corresponds to a frustum with its larger or largest diameter (dmax) adjacent to the upper surface of the tip plate. Correspondingly the tips may have a frustoconical outer shape, following the same orientation as the frustum of the flow-through openings. These frustoconical design options lead to the advantage of additional space between adjacent tips around the part of the tips protruding the tip plate body downwardly (in the operational position). In other words: At their upper end (in the operational position) the tips are arranged as close as possible to allow the highest packing density possible, while the tip design toward their lower end is selected to provide the largest possible distance (clearance) between adjacent tips. This design allows a synergetic combination of flow characteristic, reduction in material and cooling effects.
At least 50% (or ≥70% or ≥90%) of adjacent tips should have a minimum distance at their lower, free, protruding end of at least 0.23 dmax and 0.45 dmax at most. Starting from one or more typical dimensions as quoted above the minimum distance should be 0.8 mm. According to different embodiments this limit may be set at 0.85, 0.90, 0.95, 1.0, 1.05, 1.1, 1.15 or 1.2.
The frustoconical shape of the tips allows further optimizations: According to one embodiment the lowermost end of the tips, i.e. the end opposite to the upper surface of the tip plate, is made of a different alloy than the upper part to provide different contact angles between precious metal, glass and environment. While Pt/Rh alloys like Pt/Rh 90/10 have generally proved suitable for a tip plate and its tips, the alloy of the lowermost end of the tips may now comprise one or more further alloy materials like gold. Another option is to replace Rh and/or Pt at least partly by Au, in all cases allowing to increase the contact angle compared with a Pt/Rh alloy. Pt/Au 95/5 and Pt/Rh/Au 90/5/5 alloys have a larger contact angle A than Pt/Rh 90/10. A larger contact angle reduces the risk that a melt drop accidentally formed at the outlet end of one tip also influences the melt behavior and fibre production at the outlet end of an adjacent tip. In other words: The inventive design reduces the risk of a disruption during fibre production (which can lead to a flooding of the tip plate) and/or allows to reduce the distance between adjacent tips at their lower end while keeping the manufacturing conditions unchanged.
As already mentioned above the arrangement of the tips along a first and second virtual line (L1, L2), optionally (as in most cases) also along at least a third, fourth etc. line will typically be duplicated several times to provide a larger tip plate (area) with more tips. In other words: The tip plate may then comprise >10 or >20 arrangements of two or more (virtual) lines with tips as mentioned before, typically with cooling fins in between. These cooling fins will extend between adjacent arrangements of tips and at the lower surface of the tip plate.
The specific arrangement of the tips as mentioned above requires corresponding manufacturing techniques in view of the dimensions and accuracy. This can be realized if at least 50%, better ≥70%, ≥80%, ≥90% or 100% of the tip plate volume being produced by additive manufacturing, also referred to as 3D printing technology or 3D laser printing. Additive manufacturing allows the arrangement of the tips/orifices in the disclosed manner at the upper surface of the tip plate while at the same time allowing to design bespoke tip geometries (frustums, truncated cones, frustoconical shapes) toward their opposite end and the required distances between adjacent tips at their melt outlet end. The final shape is built up subsequently (step by step) in numerous individual “printing steps”, allowing to modify the layout in the described manner and even to modify the layout (physical structure) between subsequent manufacturing sequences, e.g. by different laser intensities. Punched orifices or welded tips can be avoided.

Finally the invention also relates to a bushing for receiving a high-temperature melt and comprising a tip plate in its broadest embodiment and optionally including one or more features as mentioned before. The bushing may also be made partly or completely by additive manufacturing.

Further features of the invention may be derived from the sub-claims and the other application documents. The inventions will now be described with reference to the attached drawing, showing in a very schematic way in

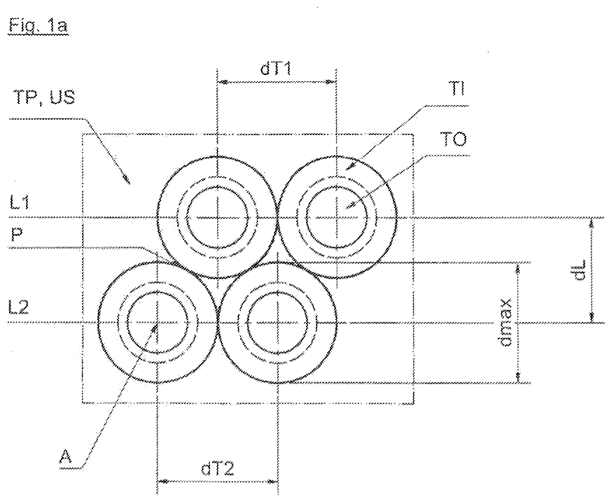

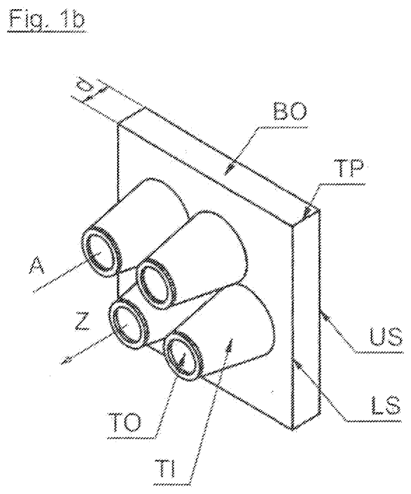

FIG. 1a: a top view of a first embodiment of a part of an upper side of a tip plate with a few exemplary tips

FIG. 1b: a perspective view of the tips according to FIG. 1a,

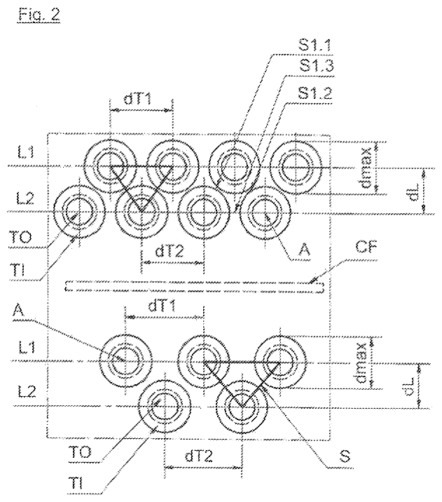

FIG. 2: a top view of a second embodiment of a part of an upper side of a tip plate with two groups of exemplary tips

FIGS. 1a and 2 display the x-y plane of the coordinate system. In the Figures the same parts or parts of substantially equivalent function or behavior are characterized by the same numerals.

FIG. 1a is a top view on a part of an upper surface US of a tip plate TP and shows two virtual straight lines L1, L2, which extend parallel to each other at a distance dL. Along both lines L1, L2 a multiplicity of upper ends of flow-through openings TO of tips TI are visible, placed side by side. For simplification only two tips TI are displayed along each line L1, L2. Each of the tips TI provides a flow-through opening TO of substantially circular cross section of diameter dmax at the upper surface US and the tips TI of one row (along L1) “overlap” the tips TI of the adjacent row (along L2). In this embodiment dL corresponds to 0,866 dmax, which leads to a design, wherein adjacent tips TI (or their flow-through openings TO respectively) touch each other at one common point P along their respective peripheries. Accordingly the distances dT1 between adjacent tips TI of virtual straight line L1 and dT2 between adjacent tips TI of virtual straight line L2 correspond to dmax and the central longitudinal axes A of three adjacent flow-through openings TO form an equilateral triangle, representing a favorable high packing density.

The tips TI extend downwardly from the upper surface US, thereby penetrating a body BO of the tip plate TP (of thickness d) and protruding downwardly from a lower surface LS of the tip plate TP as shown in FIG. 1b, from which the wall thickness of the protruding part of tips TI and the frustoconical outer shape of the tips TI may be seen, symbolized in FIG. 1a by inner closed and dotted lines within through flow openings TO of tips TI. This design leads to the favorable effect of spaces between adjacent tips TI, which allow cooling air to pass therethrough. The flow direction (z) of the glass melt or the drawing direction of the glass fibres respectively through said tips TI is characterized by arrow Z (=z-direction of the coordinate system in a use position of tip plate TP).

The embodiment of FIG. 2 differs from that of FIG. 1 by the arrangement and distances of tips TI to each other.

In the upper part of FIG. 2 the distance dT1 between central longitudinal axes A of adjacent tips TI of virtual straight line L1 and in the same manner the distance dT2 between tips TI of virtual straight line L2 have been enlarged to ca. 1.2 dmax each, while the distance dL between lines L1, L2 is the same as in FIG. 1. This leads to larger distances between the peripheries of tips TI along the same virtual straight lines L1 or L2 compared to adjacent tips TI of different lines L1, L2 and finally to a design, wherein the connection of three central longitudinal axes A of three adjacent tips TI from the 2 lines L1, L2 defines an isosceles triangle (symbolized by bold lines) with spaces S1.1, S1.2, S 1.3 between adjacent tips TI (orifices). While the corresponding packing density is less than in FIG. 1 this embodiment still defines a high packing density.

In the lower part of FIG. 2 the distances between adjacent tips TI along lines L1 and L2 have been further enlarged (dT1=1.5 dmax, dT2=1.5 dmax) thus with increasing spaces S between adjacent tips TI.

Between the upper and lower part of FIG. 2 a cooling fin CF may be seen, which is not part of the tip plate TP and arranged between the described adjacent arrangements of tips TP.

All tip plates TP and associated parts have been manufactured by additive manufacturing, using a PtRh 90/10 alloy to provide a monolithic tip plate TP.

1. Tip plate (TP) for a bushing for receiving a high-temperature melt, comprising—in its operational position—an upper surface (US), which extends in two directions (x,y) of the coordinate system, a lower surface (LS) at a distance (d) to the upper surface (US) and a body (BO) in between, as well as a multiplicity of tips (TI) with flow-through openings (TO) of substantially circular cross-section in the x-y-directions and their largest diameter (dmax) adjacent to the upper surface (US) of the tip plate (TP), which tips (TI) extend from the upper surface (US) through the body (BO) and protrude the lower surface (LS) and through which the high-temperature melt may leave the tip plate (TP) in a third (z) direction of the coordinate system, wherein
a) a first multiplicity of tips (TI) being arranged side by side such that a central longitudinal axis (A) of each corresponding flow through opening (TO) intersects a virtual first straight line (L1) and adjacent central longitudinal axes have a distance (dT1) of ≥1.0 dmax to ≤1.3 dmax,
b) a second multiplicity of tips (TI) being arranged side by side such that a central longitudinal axis (A) of each corresponding flow-through opening (TO) intersects a virtual second straight line (L2) and adjacent central longitudinal axes have a distance (dT2) of ≥1.0 dmax to ≤1.3 dmax,
c) the virtual first straight line (L1) and the virtual second straight line (L2) extend parallel to each other at a distance dL=≥0,866 dmax and <1.0 dmax.

2. Tip plate according to claim 1, wherein more than 50% of the central longitudinal axes (A) of adjacent flow-through openings (TO) of all tips (TI) along the first and second virtual straight line (L1, L2) have the same distance (dT1, dT2) to each other.

3. Tip plate according to claim 1 with dT1, dT2 or both being ≤1.2 dmax.

4. Tip plate according to claim 1, wherein more than 50% of the central longitudinal axes (A) of the flow-through openings (TO) of all tips (TI) along the virtual first and second straight line (L1, L2) are arranged such that the central longitudinal axes (A) of two adjacent through openings (TO) along one virtual straight line (L1, L2) and one flow-through opening (TO) of the adjacent virtual straight line (L2, L1) form an isosceles or an equilateral triangle.

5. Tip plate according to claim 1, wherein the flow-through openings (TO) have an inner shape, which corresponds over at least 70% of their total length—in the z direction—to a frustum with its larger diameter toward the upper surface (US) of the tip plate (TP).

6. Tip plate according to claim 1, wherein the tips (TI), along their protruding part, have a frustoconical outer shape, with their larger cross sectional areas toward the lower surface of the tip plate (TP).

7. Tip plate (TP) according to claim 1, wherein the arrangement of tips (TI) along a virtual first and second straight line (L1, L2) is extended by one or more virtual straight lines along which further tips (TI) are arranged in an analogous manner.

8. Tip plate (TP) according to claim 1, wherein at least 50% of adjacent tips (TI) have a distance at their free protruding ends of between 0.8 mm and 1.1 mm.

9. Tip plate (TP) according to claim 1 with at least 50% of its volume being produced by additive manufacturing.

10. Bushing for receiving a high-temperature melt, comprising a tip plate (TP) according to claim 1.
